(19) United States
(12) Patent Application Publication
(10) Pub. No.: US 2021/0173074 A1
(43) Pub. Date: Jun. 10, 2021

(54) Power-Efficient Multi-Beam Phase-Attached Radar/Communications

(71) Applicant: US Govt as represented by Secretary of Air Force, Wright-Patterson AFB, OH (US)

(72) Inventors: Cenk Sahin, Oakwood, OH (US); Patrick McCormick, Fairborn, OH (US); Justin Metcalf, Norman, OK (US)

(21) Appl. No.: 17/109,635

(22) Filed: Dec. 2, 2020

Related U.S. Application Data
(60) Provisional application No. 62/943,365, filed on Dec. 4, 2019.

(51) Int. Cl. G01S 13/87; H01Q 3/34

(52) U.S. Cl. CPC G01S 13/87; H01Q 3/34

(57) ABSTRACT

Multi-function waveforms possessing simultaneous radar and communication capabilities provide the means with which to efficiently combat congestion of the spectrum. Here a joint coding/spatial diversity radar/communication waveform design approach is introduced for use with digital antenna arrays. The proposed approach combines the recently developed phase-attached radar/communication (PARC) approach with the far-field radiated emission design (FFRED) formulation to realize the transmission of multiple independent data streams in arbitrary spatial directions concurrently with active radar sensing that is minimally impacted. The resulting physical signals emitted from the elements of the multiple-input multiple-output (MIMO) array have a desirable structure that is constant-modulus and have improved spectral containment relative to the original FFRED formulation.

### CROSS-REFERENCE TO RELATED APPLICATIONS

This application claims the benefit of priority under 35 U.S.C. § 119(e) to U.S. Provisional Application Ser. No. 62/943,365 entitled “Power-Efficient Multi-Beam Phase-Attached Radar/Communications”, filed 4. Dec. 2019, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### DETAILED DESCRIPTION

According to aspects of the present disclosure, multi-function waveforms with simultaneous radar and communication capabilities provide the means to efficiently use the RF spectrum to combat spectral congestion. Here a joint coding/spatial diversity radar/communication waveform design approach for digital arrays is introduced. The proposed approach combines the phase-attached radar/communication (PARC) and the far-field radiated emission design (FFRED) approaches to transmit independent communication data streams in multiple arbitrary spatial directions. In addition, the impact of the added communication functionality on radar performance is kept minimal by maintaining a degree of coherence across the pulse-to-pulse changing emissions, and by achieving unit peak-to-average power ratio (PAPR) emissions. Furthermore, the proposed approach reduces spectral spreading that is otherwise observed with the FFRED waveforms.

The present disclosure provides performing radar and communication functions simultaneously over the same spectral bandwidth from a digital array without disrupting the radar operation, which is the primary function. In general radar and communication functions have conflicting requirements. It is challenging to maintain radar performance while also performing communication function, in particular with high data rates. In one or more embodiments, the present disclosure provides for Mbps data rates. One of the purposes of the present disclosure is to keep the all resources available to the radar operation despite the added communication functionality. In particular, all elements of the digital array are used for radar operation to achieve maximum spatial resolution and the entire available spectrum is used for radar operation to maximize the range resolution. Another consideration with the invention is to maintain power efficiency by achieving unit peak to average power ratio so that the energy incident on targets of interest is maximized. This is an easy problem in the absence of the communication functionality, but with the addition of communication functionality it becomes challenging to limit the waveforms' power across the array elements. In addition, with some forms of joint radar/communication operation, the clutter response spreads into the entire range-Doppler response. The purpose is to limit this phenomenon to maintain detection performance. Most importantly the invention aims to produce spectrally well-contained emissions to limit interference to systems operating in adjacent frequency bands.

The present disclosure combines two approaches. The first approach is a coding diversity approach called phase-attached radar communications. This approach is described in U.S. patent application Ser. No. 62/903,615, filed on 20 Sep. 2019 and entitled “A Continuous-Phase Modulation Based Power-Efficient Tunable Joint Radar/Communications System,” the disclosure of which is hereby incorporated by reference in its entirety and attached as APPENDIX A. This PARC approach is able to transmit communication data in the main beam of a pulsed radar with Mbps data rates while achieving unit peak-to-average power ratio and good spectral containment. It also limits the impact of communication functionality on radar performance.

The second approach is called far-field radiated emission design (FFRED). This FFRED approach is described in U.S. patent application Ser. No. 62/928,307, filed on 30 Oct. 2019 and entitled “Physical Waveform Optimization for Multiple-Beam Multifunction Digital Arrays” the disclosure of which is hereby incorporated by reference in its entirety and attached as APPENDIX B. FFRED used a digital array to emit a radar signal in the emission main beam and communication signals in the sidelobe region of the radar main beam. Like PARC, FFRED also achieves unit PAPR across the array elements, and limits the impact of communication function on radar performance. However, it also suffers from spectral spreading.

In the present disclosure, PARC and FFRED approaches are combined to transmit communication data in all spatial directions (both main beam and side-lobe region) simultaneously while achieving Mbps data rates in each data stream. In addition the combined FFRED+PARC approach limits the spectral spreading that is otherwise observed with the FFRED approach. The present disclosure is further described in Appendix C, which is attached hereto and incorporated by reference in its entirety.

Power-Efficient Multi-Beam Phase-Attached Radar/Communications:

Multi-function waveforms possessing simultaneous radar and communication capabilities provide the means with which to efficiently combat congestion of the spectrum. Here a joint coding/spatial diversity radar/communication waveform design approach is introduced for use with digital antenna arrays. The proposed approach combines the recently developed phase-attached radar/communication (PARC) approach with the far-field radiated emission design (FFRED) formulation to realize the transmission of multiple independent data streams in arbitrary spatial directions concurrently with active radar sensing that is minimally impacted. The resulting physical signals emitted from the elements of the multiple-input multiple-output (MIMO) array have a desirable structure that is constant-modulus and have improved spectral containment relative to the original FFRED formulation.

INTRODUCTION: The loss of spectrum to commercial entities combined with increasing requirements for defense communication networks continues to reduce the available spectrum for radar systems [1]. As a result, it will become increasingly difficult to ensure successful operation of radar systems using the traditional single-function, fixed-band spectrum allocation framework. To combat growing spectral congestion while enabling successful operation of both radar and communication systems, a great deal of recent research has been dedicated to developing new techniques and paradigms to share spectrum between radar and communications functions [2]. Spectrum sharing approaches can be roughly divided into two categories [3]: co-existence approaches that focus on managing or reducing the cross-function interference from separate radar and communication systems (e.g. [4]-[6]), and co-design approaches that strive to improve the efficiency of spectral usage by developing dual-function systems having both radar and communication capabilities [7]-[16]. Here we specifically focus on the co-design problem.

Dual-function system design requires the use of some manner of waveform diversity [17], such as temporal [18], spectral [14], spatial [7], [10], [12], [13], [18] or coding diversity [8], [9], [11], [16]. Of course, temporal sharing further exacerbates an already difficult resource management problem by reducing the available time for radar operation to an unacceptable level. Traditional spatial diversity techniques such as sub-arraying reduce the achievable spatial gain and angular resolution of the individual transmit beams [18]. Such techniques also must be carefully considered so that spatial sidelobes of the sub-arrays do not interfere with one another. In contrast, here a new combination of coding and spatial diversity is considered as a means to improve spectral efficiency while imposing minimal degradation to radar functionality.

To achieve a coding diversity form of joint radar/communications the radar emission is varied on a pulse-to-pulse basis as a function of the communication sequence, with the set of all radar emissions thereby forming a communication alphabet. However, doing so also incurs range sidelobe modulation (RSM) of clutter [8], [19], which reduces target detection performance due to increased residual interference after clutter cancellation. That said, the phase-attached radar communication (PARC) approach [11] was recently introduced to control the impact of RSM on radar performance through the use of several tunable parameters. In addition, PARC waveforms have an FM structure, which is constant-modulus and continuous-phase, thereby ensuring both power and spectral efficiency.

Spectrum sharing via spatial diversity involves the use of an antenna array to transmit radar and communication signals simultaneously in distinct spatial directions. To preserve radar performance and due to the substantial differences between one-way and two-way path losses, the communication signal is typically emitted at a lower power via the sidelobe region [12], [13]. Far-field radiated emission design (FFRED) [12] is a general spatial diversity waveform design approach that realizes a (correlated) physical MIMO emission that has been demonstrated experimentally [20]. The FFRED approach also constrains the emitted waveforms to be constant-modulus, which results in a minimal loss in mainlobe (radar) transmit power. These constant-modulus waveforms are designed such that they combine in arbitrary desired spatial directions to form the intended radar and communication signals. Moreover, FFRED enables data rates on the order of the time-bandwidth product multiplied by the pulse repetition frequency (PRF) without compromising the radar timeline.

It is important to note that PARC was devised as a means to incorporate communications into the radar mainbeam while FFRED generates separate radar and communication beams. In addition, in some cases FFRED emissions can cause spectral spreading relative to the baseline radar-only signal. Here we combine the PARC and FFRED approaches to form a joint coding/spatial diversity MIMO waveform design that is able to transmit data in multiple spatial directions simultaneously, including the radar main beam, with limited impact on radar performance. Furthermore, the PARC structure limits the spectral spreading that can otherwise occur with FFRED waveforms.

Phase-Attached Radar/Communications (PARC)

The tunable continuous phase modulation (CPM) based PARC waveform design of [11] is a radar-embedded communication (REC) approach in which information sequences are modulated using CPM and phase-attached to a fixed (i.e. unchanging from pulse-to-pulse) polyphase-coded frequency modulated (PCFM) radar waveform [21]. The combined waveform retains the CPM structure and therefore preserves the well-known advantages of constant envelope and continuous phase. These characteristics translate to unit peak-to-average power ratio (PAPR) and good spectral containment, respectively, which ensures compatibility with high-power amplifiers required for most radar applications. In addition, the tunable parameters of PARC enable direct control of the degree of RSM by trading off communication performance (i.e. bit error rate (BER) and data throughput) [11].

We have introduced a MIMO based dual-function waveform design approach denoted as FFRED+PARC that leverages the benefits of these individual methods to perform joint radar/communications. This combined approach is capable of transmitting independent data streams in multiple spatial directions (up to the number of antenna elements) simultaneously, including in the radar mainbeam, achieving a rate on the order of the time-bandwidth product times the PRF per stream. In addition, the resultant waveforms are power efficient and spectrally well-contained. The effectiveness of the FFRED+PARC framework on spectral containment was demonstrated by numerical results in simulation, with experimental demonstration planned for the near future.

The impact of the added mainbeam communication capability on radar performance can be controlled via the tunable PARC parameters. Nevertheless, future work includes the evaluation and analysis of the RSM effect within this FFRED+PARC framework.

The following references are also hereby incorporated by reference in their entirety:

[1] C. Sahin, J. Jakabosky, P. M. McCormick, J. G. Metcalf, and S. D. Blunt, “A novel approach for embedding communication symbols into physical radar waveforms”, IEEE Radar Conference, pp. 1498â⋅fi1503, Seattle, Wash., May 2017.

[2] P. M. McCormick, S. D. Blunt, and J. G. Metcalf, “Simultaneous radar and communication emissions from a common aperture, part I: theory”, IEEE Radar Conference, Seattle, Wash., May 2017.

[3] P. M. McCormick, S. D. Blunt, and J. G. Metcalf, “Simultaneous radar and communication emissions from a common aperture, part II: experimentation”, IEEE Radar Conference, Seattle, Wash., May 2017.

[4] P. M. McCormick, C. Sahin, S. D. Blunt, and J. G. Metcalf, “Physical waveform optimization for multiple-beam multifunction digital arrays,” Asilomar Conference on Signals, Systems, and Computers, Pacific Grove, Calif., October 2018.

[5] C. Sahin, J. G. Metcalf, and S. D. Blunt, “Characterization of range sidelobe modulation arising from radar embedded-communications,” IET International Conference on Radar Systems, Belfast, UK, October 2017.

[6] C. Sahin, J. G. Metcalf, A. Kordik, T. Kendo, and T. Corigliano, “Experimental validation of phase-attached radar/communications: Radar performance,” International Conference on Radar, Brisbane, Australia, August 2018.

[7] C. Sahin, J. G. Metcalf, and S. D. Blunt, “Filter design to address range sidelobe modulation in transmit-encoded radar-embedded communications,” IEEE Radar Conference, pp. 1509â⋅fi1514, Seattle, Wash., May 2017.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method for joint coding/spatial diversity radar/communication waveform design, the method comprising:
encoding communication data in a mainbeam of a radar transmission using phase-attached radar/communication (PARC); and
encoding communication data in a sidebeam of the radar transmission using far-field radiated emission design (FFRED); and
transmitting the radar transmission.
